(19) United States
(12) Patent Application Publication
(10) Pub. No.: US 2022/0366931 A1
(43) Pub. Date: Nov. 17, 2022

(54) GENERATING SIMULATED AUDIO SAMPLES FOR PREDICTIVE MODEL TRAINING DATA

(71) Applicant: HEWLETT-PACKARD DEVELOPMENT COMPANY, L.P., Spring, TX (US)

(72) Inventors: Kathryn Janet Ferguson, Boise, ID (US); Casey Lee CAMPBELL, Boise, ID (US); Jan P. ALLEBACH, West Lafayette, IN (US); Mark Quentin SHAW, Boise, ID (US); John Stuart BOLTON, West Lafayette, IN (US); George T. CHIU, West Lafayette, IN (US); Patricia DAVIES, West Lafayette, IN (US); Guochenhao SONG, West Lafayette, IN (US); Zhiyang WEN, West Lafayette, IN (US)

(73) Assignee: HEWLETT-PACKARD DEVELOPMENT COMPANY, L.P., Spring, TX (US)

(21) Appl. No.: 17/738,501

(22) Filed: May 6, 2022

(51) Int. Cl. G10L 25/21; G10L 25/18

(52) U.S. Cl. CPC G10L 25/21; G10L 25/18

(57) ABSTRACT

An example method comprises identifying a plurality of zones of a spectrogram of an audio sample associated with an operation cycle of an imaging device, generating a set of audio models by transforming the audio sample to a power spectrum and identifying a plurality of audio features within the power spectrum and for the plurality of zones, generating a plurality of simulated audio samples using the set of audio models by adjusting an audio feature of the plurality of audio features, and outputting a set of training data including the audio sample and the plurality of simulated audio samples to train a predictive model indicative of a predicted failure of the imaging device.

### BACKGROUND

An imaging device may generate noise as the imaging device generates images on physical media or otherwise generates digital media. An imaging device includes and/or refers to a device that makes a representation of text or graphics on physical media or that makes a digital representation of text or graphics as a digital document from physical media. In some examples, the imaging device may generate audio noise in a first audio range when the imaging device is operating normally and may generate audio noise in a second audio range when the imaging device is having a failure or otherwise operating abnormally.

### BRIEF DESCRIPTION OF THE DRAWINGS

FIG. 1 illustrates an example method for generating a plurality of simulated audio samples, in accordance with examples of the present disclosure.

FIG. 2 illustrates an example device including non-transitory computer-readable storage medium, in accordance with examples of the present disclosure.

FIG. 3 illustrates an example apparatus for generating a plurality of audio samples, in accordance with examples of the present disclosure.

FIGS. 4A-4C illustrate example flow diagrams for generating simulated audio samples from received audio samples, in accordance with examples of the present disclosure.

FIGS. 5A-5C illustrate example data used to form audio models, in accordance with examples of the present disclosure.

FIG. 6 illustrates an example flow diagram for training a predictive model by generating training data, in accordance with examples of the present disclosure.

FIG. 7 illustrates example spectrograms and pressure history information from audio samples, in accordance with examples of the present disclosure.

FIG. 8 illustrates an example flow diagram for generating audio samples with impulses removed, in accordance with examples of the present disclosure.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

Documents may be used to disseminate information and may include physical or digital forms. A physical document may be produced by an imaging device based on data received from a computing device. A digital document may be produced by an imaging device by scanning data from a physical document. Various types of imaging devices produce physical documents from digital documents or produce digital documents from physical documents, such as two-dimensional (2D) printing devices, three-dimensional (3D) printing devices, multi-function printing devices, and scanners. For example, a printing device may form markings using marking material, such as using liquid print fluids or powdered toner, on media based on the data received. Example printing devices include inkjet printers, dry toner printers, liquid toner printers, and 3D powder bed inkjet printers. As other examples, scanners, such as automatic document feeder (ADF) scanners, may form digital documents by imaging text and/or graphics from a physical document. Maintenance and repair of components of the imaging device may be expensive and disruptive to a user of the imaging device. In various examples, audio samples from an imaging device may be used to determine when the imaging device is operating normally or faulty, such as abnormally, which may be indicative of a predicted failure of the imaging device. Such methods may reduce the number and duration of repairs, and may be used to detect media miss-feeds.

In various examples, audio samples may be obtained while an imaging device is operating under different circumstances. For example, the imaging device may operate with different operating characteristics for different types of operation cycles, types of media, and size of the image job, among other variations, and different audio samples may be obtained that are associated with the different operating characteristics. The audio samples may be used to generate a set of training data to train a predictive model to predict a failure of the imaging device. For example, the predictive model may provide an output indicative of the predicted failure, such as a malfunction occurring which may result in the imaging device becoming inoperable. However, it may be difficult to generate a set of training data with a quantity of audio samples that have variances there between to provide quality prediction by the predictive model. As such, the predictive model may be inaccurate until additional input data is obtained after implementing the predictive model, sometimes referred to as a “cold start.” Examples of the present disclosure generate a set of training data by obtaining an audio sample of the imaging device associated with an operation cycle (e.g., while performing an image job of a particular type), and augmenting the audio sample with simulated audio samples by assessing acoustic signatures of the audio samples and adjusting audio features associated therewith.

As used herein, a training set includes and/or refers to a plurality of audio samples and simulated audio samples used as inputs to a predictive model to predict failure of the imaging device. The training set may further include known outputs of the predictive model, such as classification of the operation cycle as normal or faulty. A plurality of audio samples may be captured from the imaging device while the imaging device is operating normally, and in some examples, operating abnormally or faulty, and is used by the predictive model to detect faults in real time audio noise generated by the imaging device which may indicate a failure or predicted failure of the imaging device. As used herein, an audio sample includes and/or refers to an audio wave recording of an imaging device over time.

As used herein, a predictive model includes and/or refers to a data model which identifies or predicts a failure of the imaging device based the real time audio noises, recorded as an audio sample. The predictive model may provide an output indicative of a faulty or normal classification of the audio sample based on patterns identified using the set of training data.

As noted above, the accuracy of the predictive model may depend on the size of the set of training data. As an example, a set of training data with greater variance may be used to train the predictive model with greater accuracy. In some examples, the audio samples may be collected using an acoustic sensor, such as a microphone in proximity to the imaging device, and the collected audio samples are augmented with the simulated audio samples. More particularly, the collected audio samples may be assessed to identify audio features and acoustic signatures of the audio features, such as temporal and spectral structure, and to generate sets of audio models indicative of the acoustic signature (e.g., pattern) of the audio features. In some examples, the audio sample may be assessed by transforming the audio sample to a spectrogram, which represents sound pressure level in both the time domain and frequency domain, and identifying different zones within an operation cycle. Each zone may be associated with different audio levels and spectral properties, such as tone frequencies (e.g., range of tones), tone components, and other properties identifiable from the spectrogram, as further described herein. At least some of the sets of audio models may be generated based on the zones, which may increase accuracy of the assessment. The simulated audio samples may be generated by adjusting audio features of the plurality and using the same to generate additional simulated audio samples for normal and faulty imaging device sound. The simulated audio samples may include adjustments to tone frequencies, broadband noises, impulse noises, and transition regions times, among other variations and as further described herein.

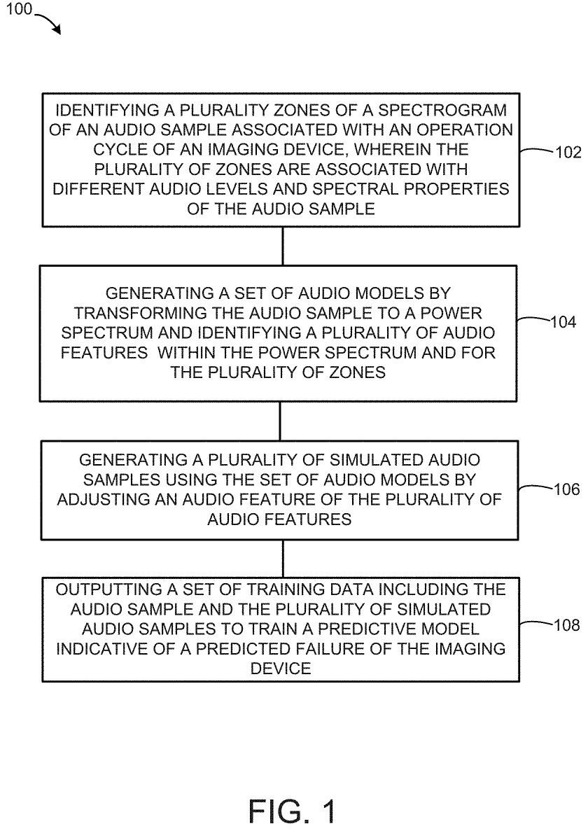

Turning now to the figures, FIG. 1 illustrates an example method for generating a plurality of simulated audio samples, in accordance with examples of the present disclosure.

At 102, the method 100 includes identifying a plurality of zones of a spectrogram of an audio sample associated with an operation cycle of an imaging device. The plurality of zones are associated with different audio levels and spectral properties of the audio sample. For example, each zone may include a time window of the total time of the operation cycle within the audio sample in which the audio sample has a relatively consistent audio level and spectral property. The audio level and spectral property (or properties) may be consistent within each zone and different between the zones. In some examples, the audio level and/or spectral property may vary by less than 10 percent within a zone, such as between 0 percent and 10 percent. In some examples, the audio level may vary by less than 3 decibels (dB) within a zone. For example, the spectrum may be analyzed to identify the plurality of zones and identify timing of the zones (e.g., zone 1=0-0.5 seconds, zone 2=0.5-0.8 seconds, etc.).

Audio level, as used herein, includes and/or refers to a relative level of the audio noise (e.g., high sound, low sound), and may apply to the whole signal of the audio sample. A power spectrum, such as a power spectral density (PSD), may be used to calculate the audio level, e.g., of sound, that applies to the whole signal. Amplitude includes and/or refers to the audio level of the tone, and not the whole signal, and may be converted to power. Power is on a dB scale. Spectral properties include and/or refer to properties identifiable from the spectrogram, such as tone frequency and other tone components, broadband noise, and/or other properties that may be identified from the spectrogram.

The operation cycle may include or be associated with generating a document (e.g., digital or physical document) while the imaging device is operating with a set of operating characteristics which define an image job. As used herein, an image job includes and/or refers to a digital document (e.g., a file) or physical document or set of files to be submitted to an imaging device, such as a data object that represents a document to be printed or a physical document to be scanned. In some examples, a user may request an image job using a computing device, and the image job is communicated to the imaging device directly by the computing device or through another local or remote computing device, such as a local or remote server. In other examples, the image job is provided directly to the imaging device, such as providing a physical document to a feeder of a scanner. As used herein, a physical document includes and/or refers to data formed on physical media, such as words and/or graphics on paper. A digital document includes and/or refers to data in an electronic form (e.g., a file), which may be stored and/or manipulated by a computing device.

In various examples, a plurality of audio samples of the imaging device may be obtained that are associated with different operation cycles and sets of operating characteristics. Example operating characteristics include a number of pages associated with the image job, a type of media, type of marking material, and/or quality of the image job (e.g., print density), among other characteristics and combinations thereof. Different image jobs may involve different types of media, different number of pages, and/or different marking material (e.g., black or color print). Example media includes paper, fabric (e.g., canvas), metal, and plastic, and different weights and/or sizes of print media, among others. In some examples, the image jobs may be set to be a threshold quality, such as using different print dot densities to print the physical document and/or using different optical resolutions for scanning a physical document to generate a digital document. Further, the operation cycle may be associated with categorization of the operation of the imaging device, such as the imaging device operating normally or faulty, e.g., abnormally.

In some examples, the method 100 may include receiving a plurality of audio samples of the imaging device that are associated with a media feed mechanism being used, without the media feed mechanism being used, with different types or weights of media, and/or using different media feed components, as further described herein. A media feed mechanism, as used herein, includes and/or refers to the feed components used to provide the media to the imaging device. Example feed components include trays that hold the media and are used to feed the media to the imaging device (sometimes herein referred to as “feed trays”), and a pick-up roller that feeds the media to the imaging device, among other components, such as additional rollers and support members.

In various examples, the audio sample may be received, such as from the imaging device or from another device having an audio sensor. The audio sample may be associated with a plurality of operation cycles, in some examples. After receiving the audio sample, the method 100 includes generating the spectrogram from the audio sample received. The spectrogram may be generated by filtering the audio sample using a high-pass filter and from the filtered audio sample, generating the spectrogram using a spectral analysis. Example high-pass filters include a Butterworth filter, a band-pass filter, and other filters or combinations thereof with a frequency cutoff of 100 Hz. Use of the high-pass filter may remove random background noise at frequencies below the frequency cutoff, and the high-pass filter may be implemented with a filter function, such as a zero-phase digital filtering or filtfilt, to prevent or mitigate introduction of additional phase to the signal. Example spectrograms include a plot of the distribution of signal power across frequency (e.g., power spectral density levels).

Identifying the zones, at 102 of method 100, may be part of a pre-analysis process performed on the audio sample(s). For example, the pre-analysis process may revise the audio sample to generate the audio models indicative of audio signatures (e.g., patterns). In some examples, the pre-analysis process may high-pass filter the audio sample to generate the filtered audio sample, and transform the filtered audio sample to a spectrogram using a spectral analysis, as described above, to prepare information to model the audio sample, such as estimating a time for generating a page of the document and identifying the plurality of zones. The pre-analysis process may further include identifying audio features associated with impulse noises, sometimes herein generally referred to as “impulse features” for ease of reference. For example, the filtered audio sample may be used to identify pressure history information, such as a graph of pressure verses time associated with the filtered audio sample. The pressure history information may be used to identify the location (e.g., a time at which the impulse occurs or appears) and a level of impulse noise, and to quantify variations in the location and level of impulse noise. Accordingly, the impulse features may include the location of impulse noise, the level of impulse noise, and the variation in location and levels of impulse noise, among other features, such as frequency response of the impulse noise, as further described herein.

At 104, the method 100 includes generating a set of audio models by transforming the audio sample to a power spectrum, and identifying a plurality of audio features within the transformed power spectrum and for the plurality of zones. As noted above, an example power spectrum includes a PSD. In some examples, the audio sample is segmented into pieces based timings of the plurality of zones and a plurality of power spectrums are generated, one for each piece of the audio sample. In some examples, the audio sample includes a plurality of each of the plurality of zones which occur in different time periods of the audio sample. As used herein, a time period of the audio sample includes a cycle of the plurality of zones, such as a length of time of the audio sample that comprises one of each of the plurality of zones in a pattern (e.g., zone 1, zone 2, zone 3, and zone 4 for a four zone example) and which may be repeated a plurality of times within the audio sample and/or include or be associated with an operation cycle.

For example, the audio sample may be segmented into pieces based on the number zones, with each zone occurring a plurality of times (e.g., forty or more zone 1 segments, forty or more zone 2 segments, forty or more zone 3 segments, forty or more zone 4 segments) across the audio sample in a plurality of time periods. As a specific example, the audio sample may include four zones which repeat across the audio sample at least forty times. The zone pieces for a particular zone across the plurality of time periods, e.g., zone 1, may be combined and/or are otherwise all used to calculate a PSD for the particular zone, e.g., combine all pieces for zone 1 and calculate PSD for zone 1. This may be repeated for each of the plurality of zones. Use of a greater number of zones may produce lower audio noise in the PSD as compared to fewer zones, and which is used to model broadband noise. In any of the examples, identified timing of the plurality of zones may be used to separate and/or isolate respective audio features associated with each zone of the plurality of zones.

Assessing and/or identifying audio features (e.g., noise characteristics) associated with the plurality of zones and timing of the plurality of zones may be used to model the audio sample and generate simulated audio samples more easily and/or accurately as compared to assessing audio features across the whole audio sample. Audio noise generated by the imaging device may repeat and/or be cyclical, which each time period or cycle (e.g., page printed or scanned) having a plurality of temporal components, such as impulsive noise (e.g., clicks and ticks), tones, and broad band noise. Identifying the timing of the zones may be used to analyze an operation cycle or groups of operation cycles, and separate out the audio features of each zone from the other zones. In contrast, analyzing each operation cycle without consideration of zones may result in the audio features of each zone being averaged with audio features of the other zones of the operation cycle, which makes simulating noise difficult.

An audio model, as used herein, includes and/or refers to an acoustic signature or pattern of audio features of a type of audio noise, such as of broadband noises, impulse noises, transitions between zones, and tone frequencies of interest. In some examples, the set of audio models may include two or more of a tone model, a broadband noise model, an impulse model, and a transition model. In some examples and as further described herein, a portion of the plurality of audio features may be identified using pressure history information.

In some examples, generating the set of audio models may include generating a tone model indicative of a first acoustic signature (e.g., pattern) of first audio features of the plurality associated with tone frequencies within the audio sample and a broadband noise model indicative of a second acoustic signature of second audio features of the plurality associated with broadband noise within the audio sample. In various examples, generating the set of audio models includes generating a transition model indicative of a (third) acoustic signature of respective audio features of the plurality associated with transitions between the plurality of zones and tonal features. In various examples, generating the set of audio models includes generating an impulse model indicative of a (fourth) acoustic signature of respective audio features of the plurality associated with impulse noise within the audio sample based on pressure history information of the audio sample. Generating each of the example audio models is further described below.

In some examples, the plurality of zones are used to generate the broadband noise model. For example, in the pre-analysis process, the time for imaging (e.g., printing or scanning) a page is used to identify each time period associated with imaging a page and to identify the plurality of zones for each time period for imaging a page. The identified plurality of zones may be used to piece apart the audio sample for each zone, and to transform the audio sample pieces by generating a power spectrum for each of the plurality of zones (e.g., combining pieces of a particular zone across a plurality of time periods of the audio sample). In some examples, the PSD across a zone may be averaged to provide an estimated PSD for each zone. The estimated PSD for each zone may include the PSD of the broadband noise, which may be used as a noise floor in the impulse model, as further described below. The steady tones may be removed from the PSD for each zone and then used to generate a broadband noise model for each of the plurality of zones with a finite impulse response (FIR) filter. The resulting broadband models may include FIR filters used to filter out impulses and other tones, such that only broadband noise remains in an audio sample and which may be used to generate simulated audio samples and/or simulated broadband noise. For example, and as further described herein, the broadband models may be used to detect broadband noise by removing impulse noise and tones from the audio sample, such as from the frequency spectrum. In some examples, tones with a frequency and amplitude modulations may be removed.

The impulse model may be generated by identifying the impulse features from the pre-analysis process, such as the described impulse noise locations, impulse noise levels, and variations in locations and audio levels from the pressure history information. Based on the locations, the impulse noises are pieced apart from the filtered audio sample, and then used to estimate frequency response due to the impulse noises and based on the noise floors identified using the broadband noise model. Impulses, as used herein, include and/or refer to audio noise in an audio sample which are below a threshold amount of time in length, such as burst of sounds above a threshold level (e.g., loud and short bursts). In some examples, the impulses may include audio noises that are less than 1 second in length and/or are above a noise threshold (e.g., a threshold above the noise floor).

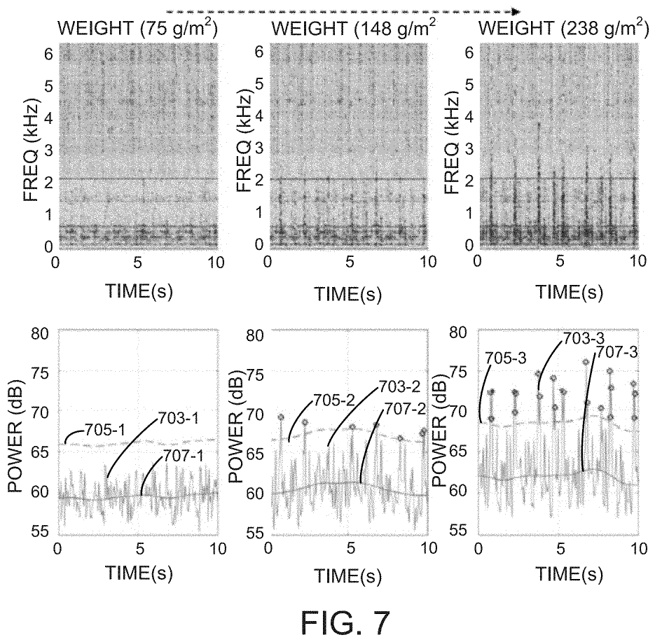

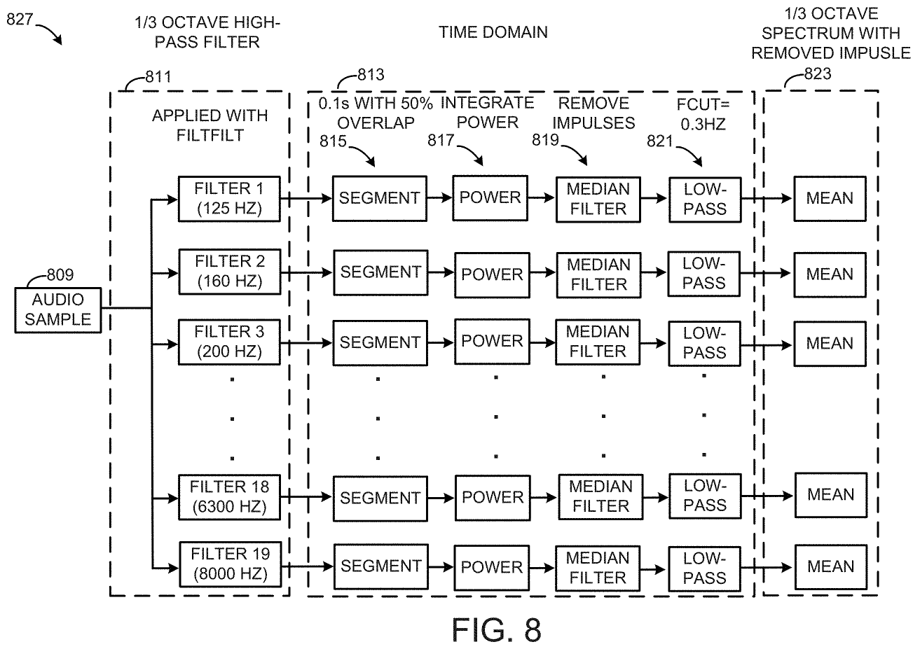

In some examples, the method 100 may include detecting the impulses within the audio sample by identifying impulse noise, such as a plurality of impulses, within the audio sample using the pressure history information (e.g., the location and levels) and summing power associated with the impulse noise to estimate the frequency response. For example, the filtered audio sample is segmented into L pieces or segments and windowed with a 0.1 second Hann window, overlapping by fifty percent to generate the pressure history information. The power is calculated every 0.5 seconds from the windowed time-domain signal (e.g., windowed, time domain signals from the pressure history information), as further illustrated by FIG. 8. The power peaks that are above the noise threshold by a set amount (e.g., 6.5 dB higher than the noise floor as further described herein) are summed to estimate the frequency response of the impulses. For example, and referring to FIG. 7, the solid lines 703-1, 703-2, 703-3 illustrate the power calculated (as described above), the dashed lines 705-1, 705-2, 705-3 illustrate noise thresholds of 6.5 dB, and the solid lines 707-1, 707-2, 707-3 illustrate the noise floors. As further described below, the noise floor of the audio sample is obtained by median (or medium) filtering the audio sample to remove peaks and then average filtering to remove the noise portion or part of. The frequency response is used to model the impulses with an FIR filter. The resulting impulse models may include FIR filters used to add impulses to the broadband noises to generate simulated audio samples, as further described herein.

Referring back to FIG. 1, in some examples, the method 100 includes generating two impulse models. The two impulse models may provide acoustic signatures for a first impulse noise and a second impulse noise which is stronger than the first impulse noise. In some examples, the impulse models may provide a Gaussian distribution of the impulse noises. The two impulse models may include the same type of model, as described below.

The tone model may be generated by transforming the audio sample to generate the power spectrum. The power spectrum may be an overall PSD for the audio sample. In other examples, the power spectrum may be a PSD for each zone, as previously described. From the power spectrum(s), the method 100 includes identifying steady tone frequencies and, optionally, removing the steady tone frequencies from the power spectrum, and assessing the remaining tone frequencies to identify tone frequencies of interest based on peaks in the power spectrum. For example, the tonal frequency of the tone frequencies of interest may be estimated and then used to extract tone power. Tone frequencies of interest, as used herein, include and/or refer to tone frequencies which may be associated with media feed noise or other imaging noises. Media feed noise includes audio noise associated with or caused by the media feed mechanism. In contrast, the steady tone frequencies may be associated with calibration noise. The method 100 may include associating tone frequencies of interest and extracted tone power with audio features of the plurality associated with tone frequencies of media (e.g., paper) feed noise, sometimes here referred to as tonal features.

In some examples, the method 100 includes generating a plurality of spectrograms of a plurality of audio samples, the plurality of spectrograms including the spectrogram and the plurality of audio samples including the audio sample, where the plurality of audio samples are each associated with a respective operation cycle of the imaging device using different sets of operating characteristics. For example, an imaging device may print or image using media of different weights and the plurality of audio samples may be associated with the different weights of the media and with calibration (e.g., no paper). Obtaining the different audio samples may be used to generate tone models for different types of media and to identify noise associated with faulty components of the imaging device. Other example operating characteristics may include use of different components for generating the document (e.g., trays, staplers, hole punch). For example, the method 100 may include obtaining a plurality of audio samples associated with different operation cycles of the imaging device using different components for imaging and generating a plurality of spectrograms therefrom. The different operation cycles may be associated with known normal operations and faulty operations.

In various examples, the transition model may be generated by identifying a transition time between zones of the plurality of zones using a spectral analysis, e.g., the spectrogram. The transition times may be between 0.5/1000 seconds and 70/1000 seconds, in some examples.

At 106, the method 100 includes generating a plurality of simulated audio samples using the set of audio models by adjusting an audio feature of the plurality of audio features. For example, the plurality of simulated audio samples may be generated by simulating each zone with steady broadband noises and tonal features using the broadband model, and then assembling each zone together using the transition model. The impulses may be simulated by using variations in the audio level and location of the impulses and/or using two impulse models to quantify and simulate the impulses with Gaussian distribution. The transition between zones and tonal features may be simulated by windowing for the transition region between zones and using the transition time to assemble the different zones together. The impulses may be added to the simulated audio sample before or after combining the plurality of zones together and using the impulse model. The tone frequencies may be added using the tonal features to generate simulated tones and which are added to the simulated audio sample without tones to generate the simulated audio sample.

In various examples, the simulated tones may be adjusted from the tones in the audio sample. For example, the tone frequency and/or time of the tone frequency may be adjusted. However examples are not so limited and other adjustments may alternatively or additionally be made. For example, the plurality of audio features may include tone frequencies, power at tone frequency, power at tone frequency relative to average, PSD peak width, modulation frequency, and modulation depth percentage.

In further examples and/or in addition, the simulated audio sample may include adjustments to impulses, such as adjustments to the location, the audio level, and/or the variation in the audio level and location, and/or adjustments to broadband noises. For example, the adjustments may be to frequency, power, PSD peak width, modulation frequency, and/or modulation depth percentage of any of the tonal features, broadband features and impulses.

At 108, the method 100 includes outputting a set of training data including the audio sample and the plurality of simulated audio samples to train a predictive model indicative of a predicted failure of the imaging device. As previously described, the set of training data may include the audio sample(s) and plurality of simulated audio samples used as known inputs and known outputs including the classification of the operation cycle as faulty (e.g., abnormal) or normal. For example, the set of training data associates the audio sample with the operation cycle, wherein the operation cycle corresponds with the imaging device operating with a set of operating characteristics, and the method 100 further includes training the predictive model using the set of training data including the audio sample as a known input and the operation cycle as a known output. In some examples, the audio samples and simulated audio samples may be processed into a feature vector which are input to the train the predictive model. The set of operating characteristics may include a type of media, a number of pages, an image job type, and a classification of the operation cycle (e.g., faulty, normal), as previously described.

In some examples, the predictive model trained by the set of training data may include an artificial intelligence (AI) model or machine learning (ML) model (MLM). In some examples, the predictive model includes a one class support vector machine (OCSVM) and/or random forest (RF) model. Various ML frameworks are available from multiple providers which provide open-source ML datasets and tools to enable developers to design, train, validate, and deploy MLMs, such as AI/ML processors. AI/ML processors (also sometimes referred to as hardware accelerators (MLAs), or Neural Processing Units (NPUs)) may accelerate processing of MLMs. AI/ML processors may be integrated circuits (ASICs) that have multi-core designs and employ precision processing with optimized dataflow architectures and memory use to accelerate and increase computational throughput when processing MLMs.

MLMs may be stored as model files having a representational data format which describes the architecture of the predictive model (e.g., input, output, hidden layers, layer weights, nodes of each layer, interconnections between nodes of different layers, and ML operations of each node/layer) along with operating parameters and, thus, describe or represent a process flow between input and output layers of an MLM. After development, the MLM may be deployed in environments other than the environment or framework in which the model was initially trained. For example, distributing computing devices of a cloud system may train the MLM and distribute the trained MLM to local computing devices and/or printer devices to implement.

In some examples, the predictive model (e.g., the MLM) is used to predict failure of the imaging device and/or components of the imaging device that are failing. For example, the method 100 may include predicting the media feed noise is indicative of faulty device operations of the imaging device, which may be caused by a predicted failure of the imaging device or component of the imaging device. By predicting the failure of the imaging device or component of the imaging device, a service provider may initiate a replacement order of the component or initiate a service order for a mechanic representative to visit the location of the imaging device in advance of the imaging device being inoperable, thereby reducing costs caused by a rushed service, such as rushed shipping costs, labor costs (e.g., costs due to overtime and/or holidays), and/or violating or triggering contractual agreed to terms. In some examples, the method 100 may further include providing a notification to a user associated with the imaging device, based on an output of the predictive model being indicative of the predictive of a failure of the imaging device.

In some examples, the method 100 includes automatically initiating a replacement order corresponding to a failing component of the imaging device and/or initiating a service order, which may occur before the imaging device and/or component fails. In some examples, users of imaging devices may generate documents within a contractual system. For example, the contractual system may include imaging devices and/or supplies which are provided to the customer by a service provider, and the service provider may maintain the imaging devices. The service agreement may have associated terms, such as imaging costs, guaranteed document qualities, and penalties to the service provided for failure to meet a term. For example, a customer may contract with a service provider that is responsible for managing the health of the imaging device, including replacing components. By automatically initiating the replacement order, the service provider may comply with the service agreement while minimizing costs.

In various examples, the method 100 may be implemented by the imaging device. In some examples, the method 100 may be implemented by a computing device local to the imaging device, such as a local computer or a local server in communication with the imaging device. In some examples, the method 100 may be implemented by a computing device remotely located from the imaging device, such as a distributed processor that may be a part of a cloud computing system. In further examples, the method 100 may be implemented using a combination of the imaging device, the computing device local to the imaging device and/or the remote computing device.

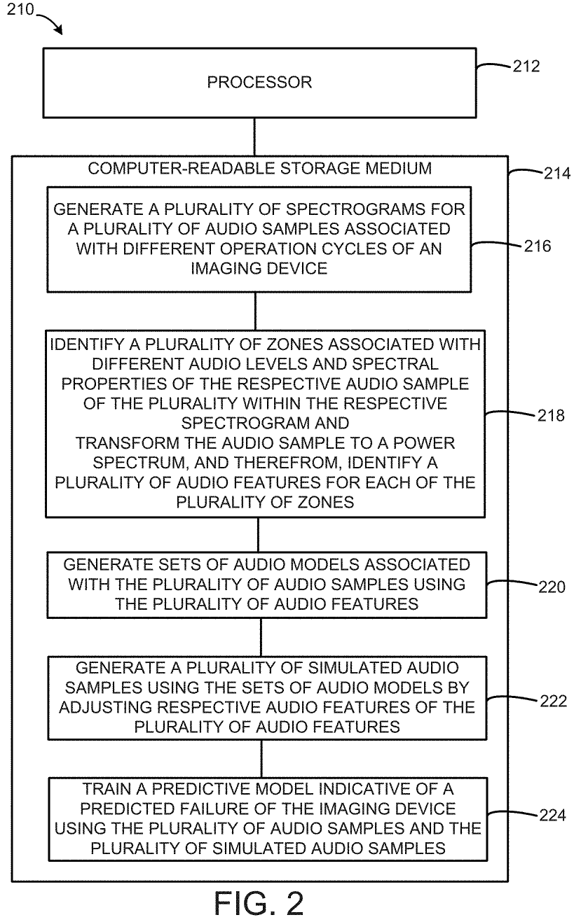

FIG. 2 illustrates an example device including non-transitory computer-readable storage medium, in accordance with examples of the present disclosure. The device 210 includes a processor 212 and memory. The memory may include a computer-readable storage medium 214 storing a set of instructions 216, 218, 220, 222 and 224.

The computer-readable storage medium 214 may include Read-Only Memory (ROM), Random-Access Memory (RAM), Electrically Erasable Programmable Read-Only Memory (EEPROM), flash memory, a solid state drive, Electrically Programmable Read Only Memory aka write once memory (EPROM), physical fuses and e-fuses, and/or discrete data register sets. In some examples, computer-readable storage medium 214 may be a non-transitory computer-readable storage medium, where the term “non-transitory” does not encompass transitory propagating signals.

At 216, the processor 212 may generate a plurality of spectrograms for a plurality of audio samples associated with different operation cycles of an imaging device. The different operation cycles may be associated with normal and faulty operations of the imaging device, as described above. In some examples, the processor 212 may further generate pressure history information for each of the plurality of audio samples. At 218, the processor 212 may, for each respective spectrogram of the plurality of spectrogram, identify a plurality of zones associated with different audio levels and spectral properties of the respective audio sample of the plurality within the spectrogram, and transform audio sample associated with the respective spectrogram to a power spectrum and, therefrom, identify a plurality of audio features for each of the plurality of zones. As previously described, in some examples, the audio sample is separated into pieces or segments based on timing of the plurality of zones and the pieces are used to generate power spectra. For example, a plurality of pieces associated with a respective zone across the audio sample (e.g., associated with a plurality of time periods) are used to generate the PSD for the respective zone, which is repeated for each of the plurality of zones. As additionally previously described, a subset of the plurality of audio features or additional audio features may be identified using pressure history information, such as the tonal features. The processor 212 may execute the instructions 216 and 218 as part of a pre-analysis process.

At 220, the processor 212 may generate sets of audio models associated with the plurality of audio samples using the plurality of audio features. The sets of audio models may include a set of audio models for each audio sample of the plurality of audio samples. For example, each of the sets of audio models may include acoustic signatures of different features of the audio samples, such as a broadband model, a tone model, an impulse model, and/or a transition model corresponding to each of the audio samples.

At 222, the processor 212 may generate a plurality of simulated audio samples using the sets of audio models by adjusting respective audio features of the plurality of audio features. For example, the different operation cycles are associated with known normal operations and faulty operations, and the plurality of simulated audio samples simulate additional normal operations and faulty operations. In some examples, tone frequencies of interest may be adjusted, such as by adjusting the power, the frequency, the time, and/or combinations thereof. In some examples, the instructions to generate the plurality of simulated audio samples include instructions, that when executed, cause the processor 212 to, for each of the simulated audio samples, adjust the respective audio feature of the plurality of audio features in each of the plurality of zones, and assemble the adjustments for each of the plurality of zones together. In some examples, one hundred ten second audio samples (ten second sounds times one hundred) may be simulated within sixty seconds. In some examples, the random audio noise (e.g., Gaussian white noise) is the input for simulation, with the simulated plurality of zones being different for different audio samples, but which may include similar properties. In some examples, as simulated, the tonal components are steady and may not have modulations. For impulse events, the variations in level and location may be quantified and simulated.

At 224, the processor 212 may train a predictive model indicative of a predicted failure of the imaging device using the audio sample and the plurality of simulated audio samples. The failure may be predicted by identifying a faulty operation and, in some examples, which may be associated with a particular component of the imaging device.

As previously described, in some examples, the processor 212 may obtain the plurality of audio samples and information on the different operation cycles of the imaging device. For example, the plurality of audio samples may be associated with recording of background audio noise in the environment that the imaging device is located in (e.g., associated with no imaging operations), imaging noise, calibration noise, imaging using different components, such as different media feed trays, imaging using different types of media having different weights, and/or imaging associated with media feed problems. In some examples, a subset of the plurality of audio samples includes faulty operation noises. For example, the faulty operation noises may be due to slip between the media and the pick-up roller, which may generate specific noises. After the slip, the imaging device may pause for a second or two, and then try again to grab the media. If the imaging device fails again, it may stop imaging operations and provide an error message to the user.

In various examples, the processor 212 and computer-readable storage medium 214 may form part of the imaging device, part of a remotely-located computing device, or part of a computing device that is local to the imaging device, such as a local server or computer and sometimes herein referred to as “a local computing device”. In some examples, the device 210 forms part of a cloud computing system having a plurality of remotely-located and/or distributed computing devices. For example, although FIG. 2 illustrates a single processor 212 and a single computer-readable storage medium 214, examples are not so limited and may be directed to devices and/or systems with multiple processors and multiple computer-readable storage mediums. The instructions may be distributed and stored across the multiple computer-readable storage mediums and may be distributed and executed by the multiple processors.

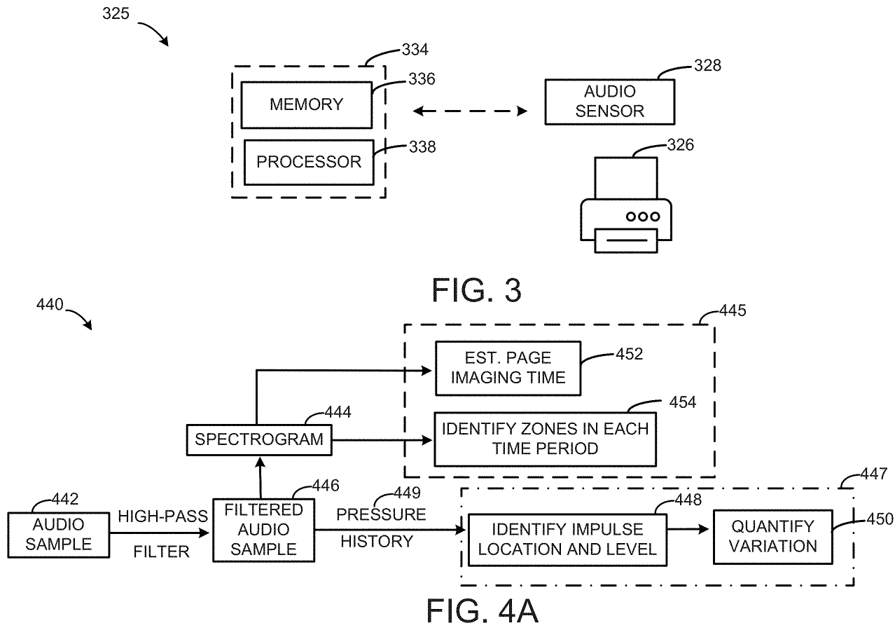

FIG. 3 illustrates an example apparatus for generating a plurality of audio samples, in accordance with examples of the present disclosure.

The system 325 include an audio sensor 328. The audio sensor 328 may capture a plurality of audio samples of an imaging device 326 operating with different sets of operating characteristics associated with normal and faulty operation cycles, as previously described. The audio sensor 328, in some examples, forms part of the imaging device 326. For example, the audio sensor 328 may include a microelectromechanical system (MEMS) microphone, or other type of microphone, internal to the imaging device 326. The audio sensor 328, which forms part of the imaging device 326, may be used to obtain additional audio samples, such as real time audio samples used to predict failures of the imaging device 326 and/or to revise the predictive model, such as using the additional audio sample to retrain the predictive model.

In other examples and/or in addition, the audio sensor 328 may form a device separate from the imaging device 326, such as a Brüel and Kjaer microphone. As previously described, the plurality of measurements may be associated with background audio noise, printing noise, calibration noise, different media trays, different media types, and media feed noise, among other audio noises.

The system 325 further includes a memory 336 and a processor 338. In some examples, the memory 336 and processor 338 may form part of a computing device 334. The computing device 334 may be local to the imaging device 326 or may include the imaging device 326 itself. In some examples, the computing device 334 is remote from the imaging device 326. The computing device 334 and imaging device 326 may communicate between one another and with other devices using data communications over the network 330. In other examples, the memory 336 and processor 338 may form part of different computing devices. The memory 336 may include a non-transitory computer-readable storage medium storing instructions executable by the processor 338, as further described herein.

In some examples, the processor 338 may execute the instructions to generate pressure history information for each of the plurality of audio samples, and generate a plurality of spectrograms from the plurality of audio samples. For each respective spectrogram of the plurality of spectrograms, the processor 338 may identify a plurality of zones associated with different audio levels and spectral properties of a respective audio sample of the plurality associated with each operation cycle, transform the audio sample associated with the respective spectrogram to generate a power spectrum (e.g., a power spectrum for each zone which includes pieces of the audio sample across a plurality of time periods), and identify a plurality of audio features associated with each of the plurality of zones from the power spectrum and using the pressure history information. The zones may be identified by estimating a time for imaging a page by the imaging device using the spectrogram, and from the time, estimating each time period for the plurality of zones (e.g., a cycle of the zones).

The processor 338 may further execute the instructions to generate sets of audio models associated with each of the plurality of audio samples using the identified plurality of audio features. The sets of audio models generated may include two or more of a tone model indicative of a first acoustic signature of first audio features of the plurality associated with tone frequencies within the audio sample, a broadband noise model indicative of a second acoustic signature of second audio features of the plurality associated with broadband noise within the audio sample, a transition model indicative of a third acoustic signature of third audio features of the plurality associated with transitions between the plurality of zones and tonal features, and an impulse model indicative of a fourth acoustic signature of fourth audio features of the plurality associated with impulse noise within the audio sample.

In some examples, the processor 338 may execute the instructions to generate a plurality of simulated audio samples using the sets of audio models by adjusting respective audio features of the plurality of audio features, and to input the plurality of simulated audio samples and plurality of audio samples to a predictive model to determine when a current audio sample of another imaging device is indicative of a fault, as previously described. The current audio sample may include a real-time audio sample, in some examples.

In some examples, the system 325 includes a plurality of distributed computing devices used to provide a service, such as a managed imaging service. The plurality of distributed computing devices may include servers and/or databases that form part of a cloud computing system. The memory 336 and processor 338 may form part of the plurality of distributed computing devices to provide the service. In some examples, one of the plurality of distributed computing devices may include the memory 336 and the processor 338. In other examples, the memory 336 may form part of a first distributed computing device and the processor 338 may form part of a second distributed computing device of the plurality.

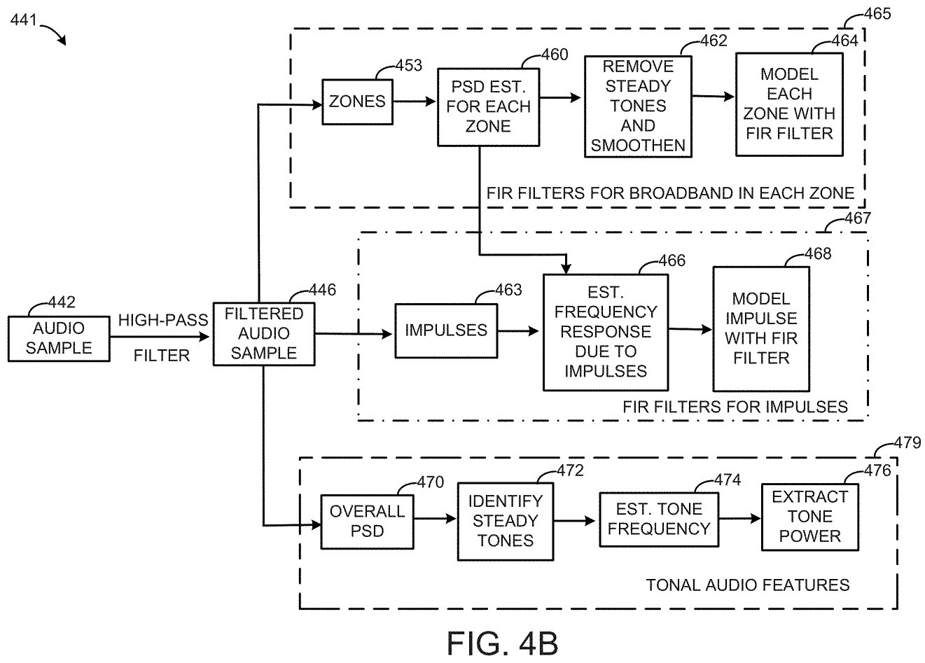

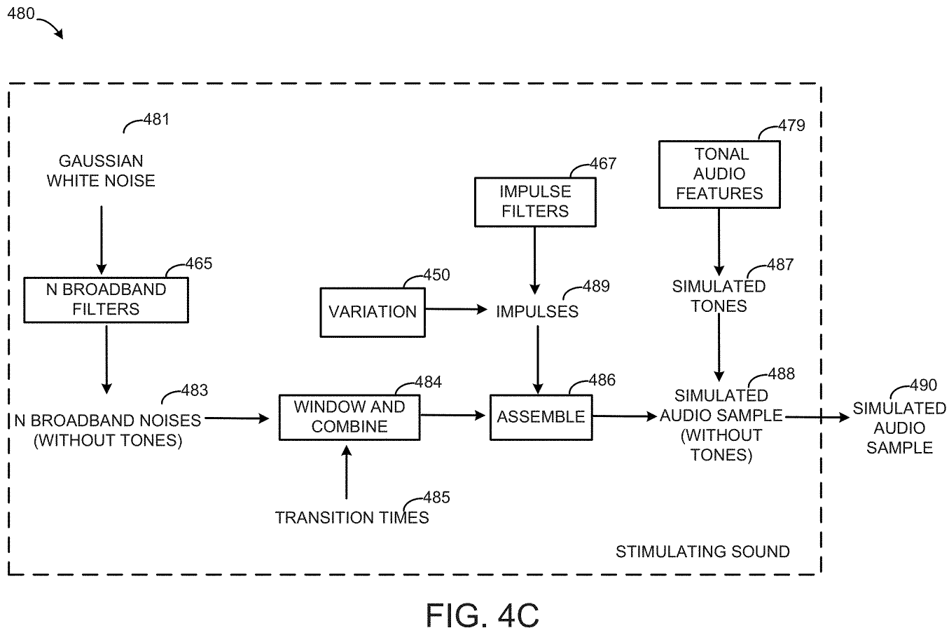

FIGS. 4A-4C illustrate example flow diagrams for generating simulated audio samples from received audio samples, in accordance with examples of the present disclosure.

FIG. 4A illustrates a flow diagram of an example pre-analysis process 440. As shown by FIG. 4A, an audio sample 442 is high-pass filtered to form a filtered audio sample 446. The filtered audio sample 446 is used to generate a spectrogram 444 and pressure history information 449. The spectrogram 444 is used to prepare information to model the plurality of zones, at 445. For example, the spectrogram 444 is used to estimate page imaging time 452, which is used to identify time periods for cycles of zones (such as printing cycles or scanning cycles for a page printed or scanned) and identify zones in each time period 454. The pressure history information 449 is used to identify tonal features, at 447. For examples, the pressure history information 449 is used identify the impulse noise location and audio level 448 and quantify variation in impulse noise location and audio level 450.

FIG. 4B illustrates an example process 441 of generating different audio models including the broadband noise models 464, the impulse model(s) 468, and the tone model including tonal features 479. As shown, the audio sample 442 is high-pass filtered to form the filtered audio sample 446.

The broadband noise modeling uses the filtered audio sample 446 and identification of the zones (e.g., 454 from FIG. 4A) to separate apart or segment the filtered audio sample 446 into pieces for each zone and across a plurality of time periods of the filtered audio sample 446, at 453, and estimate a PSD for each zone and across the plurality of time periods, at 460. The steady tones are removed from the filtered audio sample pieces and smoothed, at 462, and used to model each zone from the filtered audio sample pieces with an FIR filter, at 464. In the pre-analysis process, for each time period of the filtered audio sample 446, a broadband component is extracted for each zone (e.g., four steady broadband components for examples including four zones). The result of the broadband noise modeling includes broadband noise filters 465 for broadband noises in each of the zones. For example, the broadband noise filters 465 may be applied to an audio sample to isolate the broadband noises, and thereby remove steady tones and impulses. Further, in some examples, a feature(s) of broadband noise filters 465 may be adjusted to simulate broadband noises.

The impulse modeling uses the filtered audio sample 446 and the identification of location and audio level of the impulses (e.g., 448 from FIG. 4A) to separate apart or piece apart the impulses from the filtered audio sample 446, at 463 (e.g., from pressure history information). In some examples, the pressure history information includes the filtered audio sample 446, such as with audio samples having impulses above a threshold (e.g., strong impulses). In other examples, the pressure time history information may be obtained by band-pass filtering the audio sample 442, such as with audio samples having impulses that may be masked by other spectral properties. The band-pass filter may remove the other spectral properties. The PSD of the broadband noises, (e.g., from 460 of the broadband modeling) are used to estimate frequency response due to impulses, at 466. For example, the PSD of the broadband noises are used to identify the noise floor, with peaks in the pressure history information that are a threshold above the noise floor being identified as frequencies due to impulses. The noise floor, as previous described, may be obtained by median filtering the audio sample (or pieces) to remove peaks and then average filtering to remove the noise portions or parts of. The frequencies due to impulses are summed to estimate the frequency response of frequencies of interest and used to extract the tone power. The estimated frequencies and tone power are used to model impulses with an FIR filter, at 468. The result of the impulse noise modeling includes impulse filters 467 for generating impulses for simulated audio samples. For example, the impulse filters 467 may be used with the quantified variation in impulse noise location and audio level (e.g., 450 of FIG. 4A) to simulate impulses to add to the simulated audio samples.

The tone modeling uses the filtered audio sample 446 to estimate an overall PSD, at 470. The steady tones are identified from the overall PSD, at 472, which may be used to remove steady tones at 462, and the remaining frequency tones are used to estimate tone frequency (e.g., tones of interest), at 474, which may be associated with media feed noises. And, at 476, the tone power is extracted. The result of the tone modeling includes tonal features 479, such as the frequency of interest and power of frequencies associated with media feed noises. The tonal features 479 may be modeled to form a tone model to simulate tone frequencies. The overall PSD may be across all zones and over the total time of the audio sample. In other examples, although not illustrated by FIG. 4B, the tone modeling may use the pieces of the filtered audio sample 446, which are segmented based on zones and the pieces for each respective zone are combined across a plurality of time periods, as previously described, to generate a PSD for each zone, identify steady tones for each zone, and estimate tone frequency and tone power for each zone.

FIG. 4C illustrates an example process 480 for generating a simulated audio sample 490. The Gaussian white noise 481 of the audio sample is input and the N broadband noise filters 465 are applied to output N broadband noises 483 without tone frequencies. The Gaussian white noise is extracted from the audio sample and filtered by the various filters, as further described below, to produce simulated sound within each of the zones with particular spectral properties. Use of Gaussian white noise as the input may allow for simulating sounds which are similar but not identical. The N broadband noises 483 are windowed for the transition regions between zones and combined, at 484, using the transition times 485. For example, the window for the transition between zones may include:

window₁²+window₂²=1.

To simulate the transition region between different zones (e.g., between signal₁ and signal₂), two windows are implemented to generate the transition signal (e.g., signal=window₁×signal₁+window₂×signal₂). The transition region shows a higher sound power if the sound is interpolated with respect to sound pressure. To make a linear interpolation with respect to the sound power, the above equation is used (window₁²+window₂²=1). Example transition times 485 may include between 0.5/1000 seconds and 70/1000 seconds. The transition times 485 may be identified by selecting a starting point and window length for each zone, and adjusting based on identified spectral properties and audio levels. The combined broadband noises (e.g., broadband noises without tones) form an assembly 486 which may have impulses 489 added thereto. The impulses 489 are generated using the impulse filters 467 and the quantified variation in location and audio level 450 to form simulated audio samples without tones 488. Simulated tones 487 are added using the tonal features 479 to generate a simulated audio sample 490. In some examples, any of the broadband noises, the transition region times, the tonal components, and the impulses may the modified by adjusting respective audio features associated with the respective audio model. For example, at least one of the broadband noise filters 465 may be adjusted to generate simulated broadband noise(s). At least one of the impulse filters 467 and/or the variation in location and level 450 may be adjusted to generate simulated impulse(s). In other examples or in addition, the transition times may be adjusted between zones. As previously described, the adjusted audio features may include tone frequency, a power at tone frequency relative to average, a power at tone frequency, a PSD peak width, a modulation frequency, and a modulation depth percentage associated with broadband noises, tone frequencies, and/or impulses.

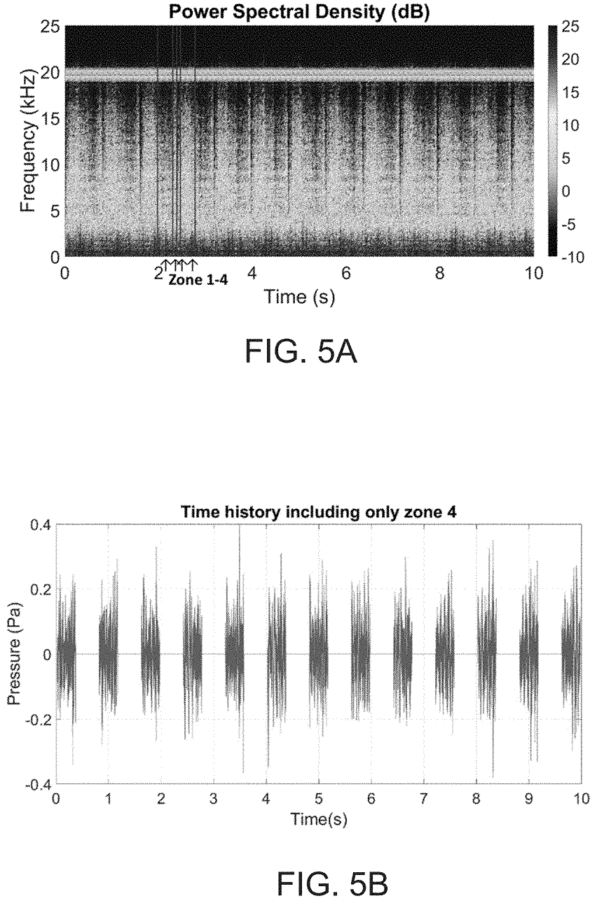

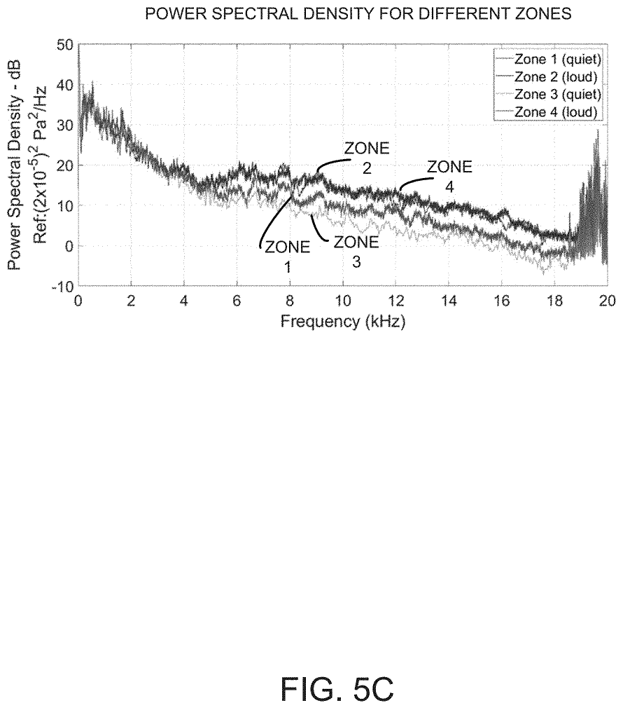

FIGS. 5A-5C illustrate example data used to form audio models, in accordance with examples of the present disclosure. For example, FIGS. 5A-5C illustrates an example process for segmenting an audio sample into pieces based on different zones and characterizing the zones from the audio sample (e.g., recording) of the imaging device. The process may include or form part of a pre-analysis process for generating simulated audio samples.

FIG. 5A illustrates an example spectrogram. More specifically, FIG. 5A is a spectrogram with the zones 1-4 (e.g., an imaging and/or printing cycle) labeled. FIG. 5B illustrates an example pressure history graph for zone 4 of FIG. 5A, and which may be generated from the filtered audio sample. FIG. 5C illustrates an example power spectrum, e.g., a PSD, generated for each of the zones 1-4. As shown, each zone is associated with a relatively constant audio level and spectral property.

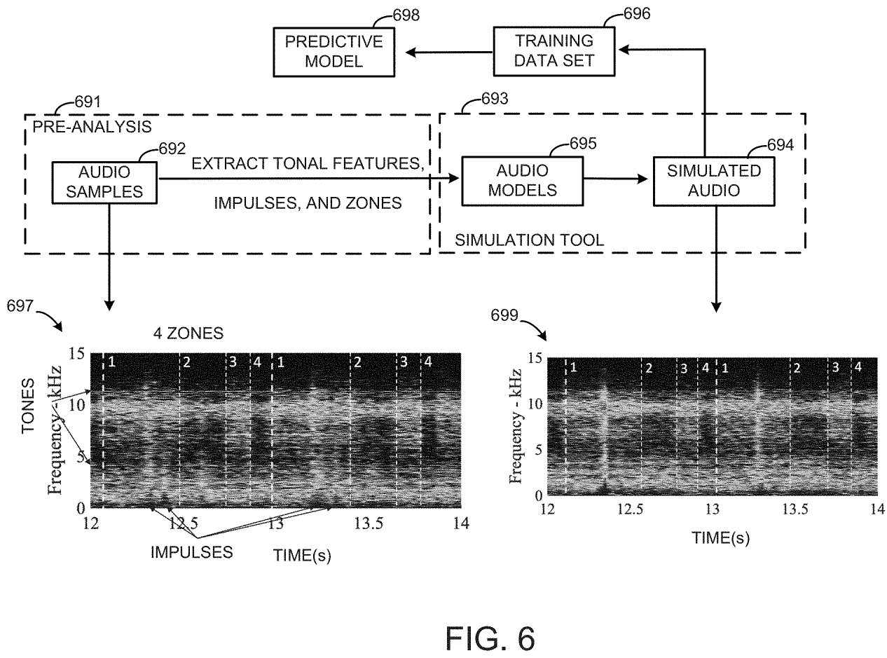

FIG. 6 illustrates an example flow diagram for training a predictive model by generating training data, in accordance with examples of the present disclosure. As shown by FIG. 6, the process includes a pre-analysis process 691 which may include at least some of substantially the same features and components as described by the pre-analysis process 440 of FIG. 4A, and a simulation tool 693 which may include at least some of the same features and components as described by the processes 441, 480 of FIGS. 4B-4C. The simulation tool 693 includes computer readable instructions that are executable by a processor.

The pre-analysis process 691 includes receiving audio samples 692 and extracting tonal features, impulses and zones, which are input to the simulation tool 693. An example spectrogram 697 of an audio sample is illustrated with the locations of the impulses, tone frequencies of interest, and zones identified by the pre-analysis process 691. The simulation tool 693 uses the inputs to generate sets of audio models 695 and to simulate audio samples 694. An example spectrogram 699 of a simulated audio sample is illustrated. The simulation tool 693 outputs a set of training data 696 to the predictive model 698, which includes the audio samples 692, the simulated audio samples 694, and classification of the operation cycles associated with the audio samples 692, 694.

FIG. 7 illustrates example spectrograms and pressure history information from audio samples, in accordance with examples of the present disclosure. More particularly FIG. 7 illustrates band-passed pressure time histories from three different audio samples. As previously described, media feed failures or issues may cause changes in tones, broadband noise, and impulse features. For example, the media feed issues may cause additional impulses. In various examples, the audio models may be generated by detecting impulses and broadband noises, which may respectively be referred to as impulse detection and a broadband detection.

In some examples, the impulse detection may occur by identifying the impulses in the audio sample and summing up the power of the impulses. FIG. 7 illustrates an example of impulse detection. As shown at the top row of FIG. 7, the spectrograms are used to identify the impulses. As previous described, the audio samples are high-pass filtered using a Butterworth filter (700-1400 Hz). The filtered audio record is segmented and windowed with a 0.1 second Hann window and fifty percent overlap. The power is calculated every 0.05 seconds from the windowed time-domain signals, as shown by the solid (power) lines 703-1, 703-2, 703-3. The noise floor of the power line is extracted using the broadband modelling, as previously described and as shown by the solid lines 707-1, 707-2, 707-3, and peaks that are 6.5 dB or more above the noise floor are identified as impulses, sometimes referred to as the noise threshold, as shown by dashed lines 705-1, 705-2, 705-3, and the powers are summed.

The broadband detection is similarly designed to output a ⅓^{rd} octave spectrum of audio noise without impulses using a similar process. For each frequency band, the noise floor of power is estimated. For example, the impulses are identified, as described above, and then removed from the audio sample to provide the broadband spectrum without the impulses (e.g., impulse events). In some examples, the broadband spectrum without impulses may be used as a feature vector for simulation and/or to train the predictive model.

FIG. 8 illustrates an example flow diagram for generating audio samples with impulses removed, in accordance with examples of the present disclosure. As shown by the flow diagram 827, the audio sample 809 is filtered, at 811, using a high-pass filter and/or a band-pass filter (as illustrated by FIG. 8) and applied with filtfilt, as previously described. A time domain process 813 is illustrated. The time domain process 813 includes segmenting and windowing the filtered audio signal into L pieces with 0.1 second Hann window and fifty percent overlap, at 815, to generate windowed time-domain signals, and calculating the power every 0.05 seconds from the windowed time-domain signals, at 817. At 819 and 821, the impulses are removed from the windowed time-domain signals by median filtering and low pass filtering the power to extract the noise floor, identify peaks a threshold above the noise floor as impulses, and remove the impulses. The median filter may include a 7-point filter. The low pass filter may include a third order Butterworth filter with a frequency cutoff of 0.3 Hz, however examples are not so limited. At 823, the output of the time domain process 813 may include a ⅓ octave spectrum with impulses removed, which may provide the broadband spectrum without impulses, as described above.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A method comprising:
identifying a plurality of zones of a spectrogram of an audio sample associated with an operation cycle of an imaging device, wherein the plurality of zones are associated with different audio levels and spectral properties of the audio sample;
generating a set of audio models by transforming the audio sample to a power spectrum and identifying a plurality of audio features within the power spectrum and for the plurality of zones;
generating a plurality of simulated audio samples using the set of audio models by adjusting an audio feature of the plurality of audio features; and
outputting a set of training data including the audio sample and the plurality of simulated audio samples to train a predictive model indicative of a predicted failure of the imaging device.

2. The method of claim 1, the method further including generating the spectrogram from the audio sample received, wherein generating the set of audio models includes generating a tone model indicative of a first acoustic signature of first audio features of the plurality associated with tone frequencies within the audio sample and a broadband noise model indicative of a second acoustic signature of second audio features of the plurality associated with broadband noise within the audio sample.

3. The method of claim 1, wherein generating the set of audio models includes generating a transition model indicative of an acoustic signature of respective audio features of the plurality associated with transitions between the plurality of zones and tonal features.

4. The method of claim 1, wherein generating the set of audio models includes generating an impulse model indicative of an acoustic signature of respective audio features of the plurality associated with impulse noise within the audio sample based on pressure history information of the audio sample.

5. The method of claim 1, wherein the set of training data associates the audio sample with the operation cycle, wherein the operation cycle corresponds with the imaging device operating with a set of operating characteristics, and the method further includes:
training the predictive model using the set of training data including the audio sample as a known input and the operation cycle as a known output.

6. The method of claim 1, further including generating a plurality of spectrograms of a plurality of audio samples, the plurality of spectrograms including the spectrogram and the plurality of audio samples including the audio sample, wherein each of the plurality of audio samples is associated with a respective operation cycle of the imaging device using different sets of operating characteristics.

7. The method of claim 1, the method further including detecting impulse noise within the audio sample by identifying impulse noise within the audio sample and summing power associated with the impulse noise.

8. The method of claim 7, the method further including detecting broadband noise within the audio sample by removing the impulse noise from the audio sample.

9. A non-transitory computer-readable storage medium storing instructions which, when executed by a processor, cause the processor to:
generate a plurality of spectrograms for a plurality of audio samples associated with different operation cycles of an imaging device;
for each respective spectrogram of the plurality of spectrograms,
identify a plurality of zones associated with different audio levels and spectral properties of a respective audio sample of the plurality of audio samples within the respective spectrogram; and
transform the audio sample associated with the respective spectrogram to a power spectrum, and therefrom, identify a plurality of audio features for each of the plurality of zones; and
generate sets of audio models associated with the plurality of audio samples using the plurality of audio features;
generate a plurality of simulated audio samples using the sets of audio models by adjusting respective audio features of the plurality of audio features; and
train a predictive model indicative of a predicted failure of the imaging device using the plurality of audio samples and the plurality of simulated audio samples.

10. The non-transitory computer-readable storage medium of claim 9, wherein:
the plurality of audio features include a tone frequency, a power at tone frequency relative to average, a power at tone frequency, a power spectral density (PSD) peak width, a modulation frequency, and a modulation depth percentage; and
the instructions to generate the plurality of simulated audio samples include instructions, that when executed, cause the processor to:
for each of the simulated audio samples,
adjust the respective audio feature of the plurality of audio features in each of the plurality of zones; and
assemble the adjustments for each of the plurality of zones together.

11. The non-transitory computer-readable storage medium of claim 9, wherein the different operation cycles are associated with known normal operations and faulty operations, and the plurality of simulated audio samples simulate additional normal operations and faulty operations.

12. An apparatus comprising:
an audio sensor to capture a plurality of audio samples of an imaging device operating with different sets of operating characteristics associated with normal and faulty operation cycles;
a processor; and
a non-transitory computer-readable storage medium storing instructions which, when executed by the processor, cause the processor to:
generate a pressure history information for each of the plurality of audio samples;
generate a plurality of spectrograms from the plurality of audio samples;
for each respective spectrogram of the plurality of spectrograms,
identify a plurality of zones associated with different audio levels and spectral properties of a respective audio sample of the plurality associated with each operation cycle;
transform the respective audio sample associated with the respective spectrogram to generate a power spectrum; and
identify a plurality of audio features associated with each of the plurality of zones from the power spectrum and using the pressure history information;
generate sets of audio models associated with each of the plurality of audio samples using the identified plurality of audio features;
generate a plurality of simulated audio samples using the sets of audio models by adjusting respective audio features of the plurality of audio features; and
input the plurality of simulated audio samples and plurality of audio samples to a predictive model to determine when a current audio sample of another imaging device is indicative of a fault.

13. The apparatus of claim 12, wherein the power spectrum includes a power spectral density (PSD).

14. The apparatus of claim 12, wherein the instructions to generate the sets of audio models include instructions that, when executed, cause the processor to generate two or more of:
a tone model indicative of a first acoustic signature of first audio features of the plurality associated with tone frequencies within the respective audio sample;
a broadband noise model indicative of a second acoustic signature of second audio features of the plurality associated with broadband noise within the audio sample;
a transition model indicative of a third acoustic signature of third audio features of the plurality associated with transitions between the plurality of zones and tonal features; and
an impulse model indicative of a fourth acoustic signature of fourth audio features of the plurality associated with impulse noise within the audio sample.

15. The apparatus of claim 12, the apparatus further including the imaging device comprising the audio sensor to obtain additional audio samples.
